(19) United States
(12) Patent Application Publication
(10) Pub. No.: US 2023/0109597 A1
(43) Pub. Date: Apr. 6, 2023

(54) CLEANING COMPOSITION

(71) Applicant: FUJIMI INCORPORATED, Kiyosu-shi (JP)

(72) Inventor: Brandon Crockett, Tualatin, OR (US)

(73) Assignee: FUJIMI INCORPORATED, Kiyosu-shi (JP)

(21) Appl. No.: 17/951,934

(22) Filed: Sep. 23, 2022

Related U.S. Application Data
(60) Provisional application No. 63/248,067, filed on Sep. 24, 2021.

(51) Int. Cl. C11D 11/00; C11D 3/04; C11D 3/12; C11D 3/30

(52) U.S. Cl. CPC C11D 11/0047; C11D 3/044; C11D 3/042; C11D 3/1226; C11D 3/30

(57) ABSTRACT

Polishing compositions are disclosed for simultaneously removing particles from a surface that has been polished using a CMP slurry comprising a polishing rate accelerator and removing a pad stain from a polishing pad that has been contacted with a CMP slurry comprising a polishing rate accelerator.

Cleaning compositions for post-CMP cleaning of semiconductor surfaces, comprise one or more reducing agents, a particle removal agent, a surfactant, and a base. When one or more reducing agents yields a standard reduction potential of less than 1.224 V, the cleaning composition of the present disclosure is able to remove a MnO₂ pad stain from a polishing pad and reduce defects on a polished surface (by removing particles).

### CROSS-REFERENCE TO RELATED APPLICATIONS

This application claims priority to U.S. Provisional Patent Application No. 63/248,067, filed Sep. 24, 2021, the disclosure of which is incorporated by reference herein in its entirety.

### TECHNOLOGICAL FIELD

The following description of the background of the present technology is provided simply as an aid in understanding the present technology and is not admitted to describe or constitute prior art to the present technology.

The present disclosure relates to the field of cleaning compositions and cleaning methods for post-CMP (chemical-mechanical polishing/planarization) semiconductor surfaces.

### BACKGROUND

Many CMP slurries and methods include metal-based, inorganic oxidizers (e.g., KMnO₄, Fenton's reagent (example: iron nitrate or a combination of iron nitrate and hydrogen peroxide), etc.) to enhance film removal rates. However, metal-based oxidizers typically precipitate metal oxide species on the polishing surface, which leads to undesirable pad staining, high defect counts, and metal contamination.

Oxide abrasives (e.g., ZrO₂, CeO₂, etc.) to be contained in slurries cause the adsorption of the oxide abrasives (post-CMP particle defects) on semiconductor surfaces due to the high attractive forces between the oxide abrasive particles and the semiconductor surfaces. The post-CMP particle defects are difficult to remove, and ammonia-containing washing solution or the like is typically employed in the post-CMP cleaning processes.

### CITATION LIST

### Non Patent Literature

### Non Patent Literature 1

W. Al-Soufi et al., A Model for Monomer and Micellar Concentrations in Surfactant Solutions: Application to Conductivity, NMR, Diffusion, and Surface Tension Data, 370 J. COLLOID & INTERFACE SCI., pp. 102-10 (2012)

### Non Patent Literature 2

Concentration-model for Surfactants Near the CMC, UNIV. SANTIAGO DE COMPOSTELA (Spain), https://www.usc.gal/fotofqm/en/units/single-molecule-fluorescence/concentration-model-surfactants-near-cmc

### Non Patent Literature 3

J. T. Davis, PROC. INT′L CONGR. SURFACE ACTIVITY, p. 426 (2nd ed., 1957)

### Non Patent Literature 4

Hydrophilic-Lipophilic Balance, WIKIPEDIA (19 Jan. 2020), https://en.wikipedia.org/wiki/Hydrophilic-lipophilic_balance

### SUMMARY

Against this backdrop, it is desirable to produce new cleaning formulations for on-platen rinse and brush box use to remove pad-staining/metal contamination from metal-based inorganic oxidizers (such as KMnO₄).

In one aspect, which may be combined with any other aspect or embodiment, the present disclosure relates to a composition for post-CMP cleaning of semiconductor surfaces, comprising: one or more reducing agents; a particle removal agent; a base; and a surfactant.

In some embodiments, the one or more reducing agents yields a standard reduction potential (E^{o}) of less than 1.224 V. In some embodiments, the one or more reducing agents comprise(s) at least one selected from sulfites, dithionates, thiosulfates, iodides, phosphites, hypophosphites, formic acid, phosphorous acid, ascorbic acid, hydrogen peroxide, hydroxylamine, oxalic acid, sodium sulfite, alkali salts thereof. In some embodiments, the reducing agent comprises ascorbic acid. In some embodiments, the one or more reducing agents is present at a concentration of 0.01 to 10 wt. %, relative to the total weight of the composition. In some embodiments, the one or more reducing agents is present at a concentration of 0.1 to 1 wt. %, relative to the total weight of the composition.

In some embodiments, the particle removal agent is citric acid, amino acid, or aminophosphonic acid. Examples of amino acid include glycine, alanine, arginine, and histidine. Examples of aminophosphonic acid include N-(phosphonomethyl)iminodiacetic acid hydrate, hydroxyphosphonoacetic acid, hydroxyethane-1,1-diphosphonic acid and 2-phosphonobutane-1,2,4-tricarboxylic acid, ethylenediaminetetramethylphosphonic acid (EDTMP), or 1-hydroxyethylidene-1,1-diphosphonic acid (HEDP). In some embodiments, the particle removal agent comprises aminophosphonic acid. In some embodiments, the particle removal agent comprises 1-hydroxyethylidene-1,1-diphosphonic acid (HEDP). In some embodiments, the particle removal agent is present at a concentration of 0.05 to 5 wt. %, relative to the total weight of the composition. In some embodiments, the particle removal agent is present at a concentration of 0.5 to 1 wt. %, relative to the total weight of the composition.

In some embodiments, the base comprises an alkylated amine. In some embodiments, the base comprises 2-(diethylamino)ethanethiol, captamine, diethylethanolamine, methylcysteamine, 2-(tert-butylamino)ethanethiol, 2,2′-dimethoxy-1,1-dimethyl-dimethylamine, 3-amino-4-octanol, 3-butoxypropylamine, N-acetylcysteamine, homocysteamine, N,N-dimethylhydroxylamine, 2-(isopropylamino)ethanol, 2-(methylthioethyl)amine, 1-aminopropane-2-thiol, leucinol, cysteamine, and/or N,O-dimethylhydroxylamine. In some embodiments, the base comprises 3-amino-4-octanol. In some embodiments, the base is present at a concentration of 0.05 to 5 wt. %, relative to the total weight of the composition. In some embodiments, the base is present at a concentration of 0.5 to 1 wt. %, relative to the total weight of the composition.

In some embodiments, the surfactant comprises a carboxylic acid surfactant. In some embodiments, the surfactant is represented by Formula (I):

CₘH₂ₘ₊₁—(OCH₂CH₂)ₙ-L-COOH (I),

where 6≤m≤20, n≥5, L is a bond, —O—, —S—, —R¹—, —S—R¹—, or —O—R¹—, where R¹ is a C1-4 alkylene. In some embodiments, the surfactant comprises capryleth-9-carboxylic acid. In some embodiments, the surfactant is present at a concentration of 0.01 to 10 wt. %, relative to the total weight of the composition. In some embodiments, the surfactant is present at a concentration of 0.1 to 1 wt. %, relative to the total weight of the composition.

In some embodiments, the composition has a pH of 2 to 6. The pH is preferably from 2 to 5, and more preferably from 2 to 4. In some embodiments, the pH is about 3.

In another aspect, the present disclosure relates to a method for simultaneously removing a pad stain from a polishing pad and removing particles from a semiconductor surface after polishing, comprising: supplying a composition for post-CMP cleaning of semiconductor surfaces to the semiconductor surface; and contacting the semiconductor surface with the polishing pad in the presence of the composition for post CMP-cleaning to produce a polished semiconductor surface having a reduced defect count. In some embodiments, the pad stain comprises MnO₂.

In some embodiments, the defect count after post-CMP cleaning (the defect count of a wafer of 300 mm in size after polishing the 300-mm wafer) (in particular, the SP1 defect count) is 100 or less. In some embodiments, the defect count is 70 or less. In some embodiments, the defect count is 50 or less. In some embodiments, the defect count is 20 or less. In some embodiments, after the cleaning, the polished semiconductor surface has a defect count of 2 or less. In some embodiments, after the cleaning, the polished semiconductor surface has a defect count of 0.

In some embodiments, the composition for post-CMP cleaning of semiconductor surfaces, comprises: one or more reducing agents; a particle removal agent; a base; and a surfactant.

In some embodiments, the one or more reducing agents yields a standard reduction potential (E^{o}) of less than 1.224 V. In some embodiments, the one or more reducing agents comprise(s) ascorbic acid, hydrogen peroxide, hydroxylamine, oxalic acid, sodium sulfite, alkali salts thereof, or any combination thereof. In some embodiments, the reducing agent comprises ascorbic acid. In some embodiments, the one or more reducing agents is present at a concentration of 0.01 to 10 wt. %, relative to the total weight of the composition. In some embodiments, the one or more reducing agents is present at a concentration of 0.1 to 1 wt. %, relative to the total weight of the composition.

In some embodiments, the particle removal agent comprises glycine, N-(phosphonomethyl)iminodiacetic acid hydrate, hydroxyphosphonoacetic acid, citric acid, hydroxyethane-1,1-diphosphonic acid, 2-phosphonobutane-1,2,4-tricarboxylic acid, or 1-hydroxyethylidene-1,1-diphosphonic acid (HEDP). In some embodiments, the particle removal agent comprises 1-hydroxyethylidene-1,1-diphosphonic acid (HEDP). In some embodiments, the particle removal agent is present at a concentration of 0.05 to 5 wt. %, relative to the total weight of the composition. In some embodiments, the particle removal agent is present at a concentration of 0.5 to 1 wt. %, relative to the total weight of the composition.

In some embodiments, the base comprises an alkylated amine. In some embodiments, the base comprises 2-(diethylamino)ethanethiol, captamine, diethylethanolamine, methyl cysteamine, 2-(tert-butylamino)ethanethiol, 2,2′-dimethoxy-1,1-dimethyl-dimethylamine, 3 -amino-4-octanol, 3-butoxypropylamine, N-acetylcysteamine, homocysteamine, N,N-dimethylhydroxylamine, 2-(isopropylamino)ethanol, 2-(methylthioethyl)amine, 1-aminopropane-2-thiol, leucinol, cysteamine, and/or N,O-dimethylhydroxylamine. In some embodiments, the base comprises 3-amino-4-octanol. In some embodiments, the base is present at a concentration of 0.05 to 5 wt. %, relative to the total weight of the composition. In some embodiments, the base is present at a concentration of 0.5 to 1 wt. %, relative to the total weight of the composition.

In some embodiments, the surfactant comprises a carboxylic acid surfactant. In some embodiments, the surfactant is represented by Formula (I):

CₘH₂ₘ₊₁—(OCH₂CH₂)ₙ-L-COOH (I),

where 6≤m≤20, n≥5, L is a bond, —O—, —S—, —R¹—, —S—R¹—, or —O—R¹—, where R¹ is a C1-4 alkylene. In some embodiments, the surfactant comprises capryleth-9-carboxylic acid. In some embodiments, the surfactant is present at a concentration of 0.01 to 10 wt. %, relative to the total weight of the composition. In some embodiments, the surfactant is present at a concentration of 0.1 to 1 wt. %, relative to the total weight of the composition.

In some embodiments, the composition has a pH of 2 to 6. In some embodiments, the pH is about 3.

In another aspect, the present disclosure relates to a method for polishing a semiconductor surface, comprising: polishing the semiconductor surface with a polishing composition comprising a removal rate enhancer; and simultaneously removing a pad stain from a polishing pad and removing particles from the semiconductor surface by any of the methods described above. In some embodiments, the removal rate enhancer comprises KMnO₄. In some embodiments, the pad stain comprises MnO₂.

Additional aspects and/or embodiments of the invention will be provided, without limitation, in the detailed description of the present technology set forth below. The following detailed description is exemplary and explanatory, but it is not intended to be limiting.

Various objects, aspects, features, and advantages of the disclosure will become more apparent and better understood by referring to the detailed description taken in conjunction with the accompanying figures.

### BRIEF DESCRIPTION OF THE DRAWINGS

FIG. 1A shows pad staining on an IC1010™ polishing pad (Dupont) after polishing with a KMnO₄-containing slurry for 60 minutes. FIG. 1B shows almost “complete” removal of the pad stain after a 30-second on-platen rinse using Composition A (ascorbic acid as reducing agent).

FIG. 2A shows a SP1 defect map from a PCVD carbon wafer polished with a KMnO₄-containing slurry, followed by an ammonia rinse without using a cleaning composition according to the present disclosure. FIG. 2B shows a SP1 defect map from a PCVD carbon wafer (obtained by mapping defects on a TEOS (silicon oxide derived from tetraethyl orthosilicate) 300-mm wafer) polished with a KMnO₄-containing slurry, followed by a pad cleaning step and on-platen rinse using Composition A.

### DETAILED DESCRIPTION OF EMBODIMENTS

In the present specification, “X to Y” indicating a range means “X or more and Y or less”. When a statement of “X to Y” is multiply given, e.g., when a statement of “X1 to Y1, or, X2 to Y2” is given, disclosure employing any of the numerical values as an upper limit, disclosure employing any of the numerical values as a lower limit, and disclosure employing any combination of such upper and lower limits are all provided (i.e., lawful support for amendment). Specifically, amendment to X1 or more, amendment to Y2 or less, amendment to X1 or less, amendment to Y2 or more, amendment to X1 to X2, amendment to X1 to Y2, and so on must be regarded as being lawful. Unless specifically stated, operations and measurement of physical properties or the like are performed under conditions of room temperature (20 to 25° C.)/relative humidity of 40 to 50% RH.

The cleaning compositions of the present disclosure leverage the reduction-oxidation behavior for reducing agents that allow for MnO₂-based pad stain removal and low defect counts, as measured by SP1. The present compositions may be applied to additional reducing agents and MOₓ-based pad-staining, so long as the general constraint E^{o}_{(reducing agent)}<E^{o}_{(metal oxide stain)} is followed.

### Reducing Agent

In some embodiments, a cleaning composition according to the present disclosure comprises a reducing agent. A reducing agent added to a clean chemistry comprising, e.g., particle removal agents affords removal of pad staining and metal contamination arising from KMnO₄-based slurries, as well as significant reduction in post-CMP defects. Preferably, complete removal is achieved. In some embodiments, the reducing agent according to the present disclosure is an agent that can be a reducing agent in an acidic region, a neutral region, or a basic region. Accordingly, for example, an acidic cleaning composition may be prepared with inclusion of an agent (reducing agent) that can be a reducing agent in a basic region. In some embodiments, the acidic region can be pH 1 or more and less than pH 7, pH 2 to 6, or pH 2.5 to 5. The pH may be any pH shown later in “pH of Composition”. In some embodiments, the neutral region can be about pH 7 (in particular, pH 7). In some embodiments, the basic region can be more than pH 7 and pH 14 or less, pH 8 to 12, or pH 9 to 11. The pH can be determined using a pH meter (e.g., LAQUA® manufactured by HORIBA, Ltd., or any other suitable pH meter).

Through the action of an oxidizer, unintended products accumulate on the surface of a pad on a platen in a polisher to become apparent as a stain. This phenomenon is called pad staining. Such stains can lead to scratches or cause pad clogging, which can interfere with the progress of polishing. Pad staining shows as surface discoloration in appearance. Examples of “defects” include abrasive grains used in a previous step, fragments broken off from a polishing pad, and water-insoluble substances in a polishing step. Some typical examples of metal contamination can include the presence of MnO₂ as a residue of metal oxide on the surface of a carbon film polished with a composition, for example, containing ZrO₂ and KMnO₄, and the presence of metal oxide such as Fe₃O₄ as a residue on the surface of tungsten polished with a composition containing SiO₂, iron nitrate, and KMnO₄. Such water-insoluble substances, such as MnO₂ and the like derived from KMnO₄ and Fe₃O₄ and the like derived from iron nitrate, can be removed with the composition of the present application. If the composition of the present application contains hydrogen peroxide, bubbles can be generated by the action for MnO₂, and the bubbles are expected to additionally assist the cleaning effect. In addition, hydrogen peroxide is particularly suitable from the viewpoint of no possibility of inhibiting the stability of the composition.

Thus, defects with Group 7 elements (e.g., MnO₂) and defects with Group 8 elements (e.g., Fe₃O₄) can be removed or reduced in number by performing a washing step with application of the cleaning composition of the present disclosure.

The use of KMnO₄ as a removal rate enhancer in CMP slurries produces manganese oxides (e.g., MnO_{2 (s)}) as a pad-staining by-product (Equation 1).

MnO₄_{^{−}}_{(aq)}+4H⁺+3e⁻⇄MnO_{2 (s)}+2 H₂O (E^{o}=1.7 V) (1)

Removing the MnO₂ pad stain can be accomplished with the use of a reducing agent in acidic media (Equation 2), as long as E° of the reducing agent is less than the E^{o} of MnO₂ (1.224 V).

MnO_{2 (s)}+4H⁺+2e⁻⇄Mn²⁺_{(aq)}+2H₂O (E^{o}=1.224 V) (2)

Thus, a composition according to the present disclosure may comprise any reducing agent with standard reduction potential E^{o}<1.224 V, which will allow pad stain removal. Further, when used in combination with particle removal agents, surfactants, and/or bases, compositions comprising such reducing agents may result in surfaces having <100 post-CMP clean defects. In some embodiments, the one or more reducing agents are each an agent that provides a standard reduction potential (E^{o}) of less than 1.224 V in an acidic region, a neutral region, or a basic region. Accordingly, for example, an acidic cleaning composition may be prepared with inclusion of an agent (reducing agent) that provides a standard reduction potential (E^{o}) of less than 1.224 V in a basic region.

In some embodiments, the one or more reducing agents comprises, consists essentially of, or consists of sulfites, dithionates, thiosulfates, iodides, phsosphites, hypophosphites, formic acid, phosphorous acid, ascorbic acid, hydrogen peroxide, hydroxylamine, oxalic acid, sodium sulfite, alkali salts thereof, or any combination thereof. In some embodiments, the one or more reducing agents comprises, consists essentially of, or consists of ascorbic acid. In some embodiments, the reducing agent(s) comprises an organic acid having a lactone structure with a hydroxy group. In some embodiments, the reducing agent(s) comprises an organic acid having a lactone structure with a plurality of (two or more, 3 or more, or 4 or more and 7 or less, 6 or less, or 5 or less) hydroxy groups. The lactone structure may be any of β-lactone, γ-lactone, δ-lactone, and ε-lactone. In some embodiments, the one or more reducing agent(s) comprises, consists essentially of, or consists of an organic acid having a lactone structure with a hydroxy group.

In some embodiments, the one or more reducing agent(s) is present in the composition at a concentration, relative to the total weight of the composition, of at least about 0.001 wt. %, at least about 0.002 wt. %, at least about 0.003 wt. %, at least about 0.004 wt. %, at least about 0.005 wt. %, at least about 0.006 wt. %, at least about 0.007 wt. %, at least about 0.008 wt. %, at least about 0.009 wt. %, at least about 0.01 wt. %, at least about 0.02 wt. %, at least about 0.03 wt. %, at least about 0.04 wt. %, at least about 0.05 wt. %, at least about 0.06 wt. %, at least about 0.07 wt. %, at least about 0.08 wt. %, at least about 0.09 wt. %, at least about 0.1 wt. %, at least about 0.2 wt. %, at least about 0.3 wt. %, at least about 0.4 wt. %, at least about 0.5 wt. % or any range or value therein between. In some embodiments, the one or more reducing agent(s) is present in the composition at a concentration, relative to the total weight of the composition, of at least about 0.6 wt. %, at least about 0.7 wt. %, at least about 0.8 wt. %, or any range or value therein between. In some embodiments, the one or more reducing agent(s) is present in the composition at a concentration, relative to the total weight of the composition, of at least about 1 wt. %, at least about 1.5 wt. %, at least about 2 wt. %, at least about 2.5 wt. %, or any range or value therein between. In a case in which a plurality of reducing agents, the concentration means the total amount. In the present specification, each plural form may be interpreted in such a way. Even when no plural form is explicitly used in the present specification, there is no limitation to the possibility of the presence of a plurality of elements.

In some embodiments, hydrogen peroxide is present in the composition at a concentration, relative to the total weight of the composition, of at least about 0.001 wt. %, at least about 0.002 wt. %, at least about 0.003 wt. %, at least about 0.004 wt. %, at least about 0.005 wt. %, at least about 0.006 wt. %, at least about 0.007 wt. %, at least about 0.008 wt. %, at least about 0.009 wt. %, at least about 0.01 wt. %, at least about 0.02 wt. %, at least about 0.03 wt. %, at least about 0.04 wt. %, at least about 0.05 wt. %, at least about 0.06 wt. %, at least about 0.07 wt. %, at least about 0.08 wt. %, at least about 0.09 wt. %, at least about 0.1 wt. %, at least about 0.2 wt. %, at least about 0.3 wt. %, at least about 0.4 wt. %, at least about 0.5 wt. %, or any range or value therein between. In some embodiments, hydrogen peroxide is present in the composition at a concentration, relative to the total weight of the composition, of at least about 0.6 wt. %, at least about 0.7 wt. %, at least about 0.8 wt. %, or any range or value therein between. In some embodiments, hydrogen peroxide is present in the composition at a concentration, relative to the total weight of the composition, of at least about 1 wt. %, at least about 1.5 wt. %, at least about 2 wt. %, at least about 2.5 wt. %, or any range or value therein between.

In some embodiments, the one or more reducing agent(s) is present in the composition at a concentration, relative to the total weight of the composition, of about 20 wt. % or less, about 19 wt. % or less, about 18 wt. % or less, about 17 wt. % or less, about 16 wt. % or less, about 15 wt. % or less, about 14 wt. % or less, about 13 wt. % or less, about 12 wt. % or less, about 11 wt. % or less, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, or any range or value therein between.

In some embodiments, hydrogen peroxide is present in the composition at a concentration, relative to the total weight of the composition, of about 20 wt. % or less, about 19 wt. % or less, about 18 wt. % or less, about 17 wt. % or less, about 16 wt. % or less, about 15 wt. % or less, about 14 wt. % or less, about 13 wt. % or less, about 12 wt. % or less, about 11 wt. % or less, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, or any range or value therein between.

For purposes of the present disclosure, the “standard reduction potential” (E^{o}) is a measure of tendency of a chemical species to acquire electrons from, or lose electrons to, an electrode and thereby be reduced, or oxidized, respectively. Standard reduction potential may be measured in volts (V), or millivolts (mV). Each chemical species has its own intrinsic standard reduction potential. In general, the more positive the reduction potential, the greater the affinity for electrons and tendency to be reduced. Standard reduction potential may be measured under standard temperature and pressure (25° C., 1 atm), with reference to a standard hydrogen electrode (SHE).

In some embodiments, the one or more reducing agents has a standard reduction potential) (E° of less than 1.224 V, less than 1.220 V, less than 1.210 V, less than 1.200 V, less than 1.190 V, less than 1.180 V, less than 1.170 V, less than 1.160 V, less than 1.150 V, less than 1.140 V, less than 1.130 V, less than 1.120 V, less than 1.110 V, less than 1.100 V, less than 1.09 V, less than 1.08 V, less than 1.07 V, less than 1.06 V, less than 1.05 V, less than 1.04 V, less than 1.03 V, less than 1.02 V, less than 1.01 V, less than 1.00 V, less than 0.95 V, less than 0.90 V, less than 0.85 V, less than 0.80 V, less than 0.75 V, less than 0.70 V, less than 0.65 V, less than 0.60 V, less than 0.55 V, less than 0.50 V, less than 0.45 V, less than 0.40 V, less than 0.35 V, less than 0.30 V, less than 0.25 V, less than 0.20 V, less than 0.15 V, less than 0.10 V, less than 0.05 V, less than 0 V, less than −0.05 V, less than −0.10 V, less than −0.20 V, less than −0.30 V, less than −0.40 V, less than −0.50 V, less than −0.60 V, less than −0.70 V, less than −0.80 V, less than −0.90 V, less than −1.00 V, less than −1.10 V, less than −1.20 V, less than −1.30 V, less than −1.40 V, less than −1.50 V, less than −1.60 V, less than −1.70 V, less than −1.80 V, less than −1.90 V, less than −2.00 V, less than −2.10 V, less than −2.20 V, less than −2.30 V, less than −2.40 V, less than −2.50 V, less than −2.60 V, less than −2.70 V, less than −2.80 V, less than −2.90 V, less than −3.00 V, or any range or value therein between. With such an upper limit (in particular, e.g., −3.04 V), the stability in water can be enhanced, unexpected reactions with other additive agents can be prevented. In some embodiments, the one or more reducing agent(s) has a standard reduction potential (E^{o}) of −3.0 V or more, −2.0 V or more, −1.0 V or more, more than 0 V, 0.1 V or more, 0.2 V or more, 0.21 V or more, 0.25 V or more, 0.3 V or more, 0.32 V or more, 0.34 V or more, 0.35 V or more, 0.4 V or more, 0.5 V or more, 0.6 V or more, 0.65 V or more, or any range or value therein between. With such a lower limit, zirconia and Mn can be ionized.

### Particle Removal Agent

In some embodiments, a cleaning composition according to the present disclosure includes a particle removal agent. The particle removal agent may be any agent suitable for removing residual particulates from the surface of a polishing object that has been polished using a chemical mechanical polishing slurry (e.g. a CMP slurry comprising ceria particles or zirconia particles). One or more particle removal agents may be present.

In an embodiment of the present invention, CMP slurries may comprise abrasive grains (particles) and a polishing rate accelerator. Examples of the abrasive grains (particles) include inorganic particles and organic particles. Specific examples of inorganic particles include metal oxide particles such as silica, alumina, ceria, titania, and zirconia, silicon nitride particles, silicon carbide particles, and boron nitride particles. Specific examples of organic particles include polymethyl methacrylate (PMMA) particles.

In an embodiment of the present invention, the particle removal agent has one or more, two or more, 3 or more, 4 or more, 5 or more, 7 or more, or 8 or more phosphonic acid groups (—P(═O)(OH)₂) or salt groups thereof, or an alkyl group substituted with one or more, two or more, 3 or more, 4 or more, 5 or more, 7 or more, or 8 or more phosphonic acid groups or salt groups thereof. In an embodiment of the present invention, the particle removal agent has 8 or less, 7 or less, 6 or less, 5 or less, 4 or less, 3 or less, or two or less phosphonic acid groups or salt groups thereof, or an alkyl group substituted with 8 or less, 7 or less, 6 or less, 5 or less, 4 or less, 3 or less, or two or less phosphonic acid groups or salt groups thereof.

In an embodiment of the present invention, the particle removal agent comprises a compound represented by N(R¹)(R²)(R³) or a salt thereof, or a compound represented by C(R¹)(R²)(R³)(R⁴) or a salt thereof.

R¹ to R³ and R¹ to R⁴ each independently represent a hydrogen atom, a carboxyl group, a hydroxyl group, a phosphonic acid group or salt group thereof, or a substituted or unsubstituted linear or branched alkyl group having 1 or more and 5 or less carbon atoms, where one or more of R¹ to R³ are each a phosphonic acid group or salt group thereof, or an alkyl group substituted with a phosphonic acid group or salt group thereof, and one or more of R¹ to R⁴ are each a phosphonic acid group or salt group thereof, or an alkyl group substituted with a phosphonic acid group or salt group thereof.

The substituted or unsubstituted linear or branched alkyl group having 1 or more and 5 or less carbon atoms as any of R¹ to R³ and R¹ to R⁴ is not particularly limited, and examples thereof include alkyl groups including a methyl group, an ethyl group, a propyl group, an isopropyl group, a butyl group, an isobutyl group, a sec-butyl group, and a tert-butyl group.

Here, “substituted or unsubstituted” for the alkyl group means that one or more hydrogen atoms of the alkyl group may be substituted with another substituent or not. Here, the substituent that may substitute is not particularly limited. Examples of the substituent include a fluorine atom (F); a chlorine atom (Cl); a bromine atom (Br); an iodine atom (I); a phosphonic acid group (—PO₃H₂); a phosphoric acid group (—OPO₃H₂); a thiol group (—SH); a cyano group (—CN); a nitro group (—NO₂); a hydroxy group (—OH); a linear or branched alkoxy group having 1 or more and 10 or less carbon atoms (e.g., a methoxy group, an ethoxy group, a propoxy group, an isopropoxy group, a butoxy group, a pentyloxy group, a hexyloxy group, a 2-ethylhexyloxy group, an octyloxy group, a dodecyloxy group, etc.); an aryl group having 6 or more and 30 or less carbon atoms (e.g., a phenyl group, a biphenyl group, a 1-naphthyl group, a 2-naphthyl group); and a cycloalkyl group having 3 or more and 20 or less carbon atoms (e.g., a cyclopropyl group, a cyclobutyl group, a cyclopentyl group, a cyclohexyl group, a cycloheptyl group).

Here, the alkyl group substituted with a phosphonic acid group or salt group thereof is a linear or branched alkyl group having 1 or more and 5 or less carbon atoms and substituted with one or more phosphonic acid groups or salt groups thereof, and examples thereof include a (mono)phosphonomethyl group, a (mono)phosphonoethyl group, a (mono)phosphono-n-propyl group, a (mono)phosphonoisopropyl group, a (mono)phosphono-n-butyl group, a (mono)phosphonoisobutyl group, a (mono)phosphono-s-butyl group, a (mono)phosphono-t-butyl group, a diphosphonomethyl group, a diphosphonoethyl group, a diphosphono-n-propyl group, a diphosphonoisopropyl group, a diphosphono-n-butyl group, a diphosphonoisobutyl group, a diphosphono-s-butyl group, a diphosphono-t-butyl group, or salt groups thereof.

In an embodiment of the present invention, examples of salts include alkali metal salts such as sodium salts and potassium salts, salts of Group 2 elements such as calcium salts and magnesium salts, amine salts, and ammonium salts.

In some embodiments, the particle removal agent may comprise, consist essentially of, or consist of a protic organic acid molecule. In some embodiments, the protic organic acid molecule may comprise, by way of non-limiting example, glycine, N-(phosphonomethyl)iminodiacetic acid hydrate, hydroxyphosphonoacetic acid, citric acid, hydroxyethane-1,1-diphosphonic acid, and 2-phosphonobutane-1,2,4-tricarboxylic acid. In some embodiments, the particle removal agent comprises hydroxyethane-1,1-diphosphonic acid, 2-phosphonobutane-1,2,4-tricarboxylic acid, or combinations thereof In some embodiments, the particle removal agent comprises, consists essentially of, or consists of hydroxyethane-1,1-diphosphonic acid (HEDP). In some embodiments, the protic organic acid molecule does not substantially contain low trace metals. A single particle removal agent may be used, or two or more particle removal agents may be used in combination.

In some embodiments, the particle removal agent is present in the composition at a concentration, relative to the total weight of the composition, of at least about 0.001 wt. %, at least about 0.002 wt. %, at least about 0.003 wt. %, at least about 0.004 wt. %, at least about 0.005 wt. %, at least about 0.006 wt. %, at least about 0.007 wt. %, at least about 0.008 wt. %, at least about 0.009 wt. %, at least about 0.01 wt. %, at least about 0.02 wt. %, at least about 0.03 wt. %, at least about 0.04 wt. %, at least about 0.05 wt. %, at least about 0.06 wt. %, at least about 0.07 wt. %, at least about 0.08 wt. %, at least about 0.09 wt. %, at least about 0.1 wt. %, at least about 0.2 wt. %, at least about 0.3 wt. %, at least about 0.4 wt. %, at least about 0.5 wt. % or any range or value therein between.

In some embodiments, the particle removal agent is present in the composition at a concentration, relative to the total weight of the composition, of about 20 wt. % or less, about 19 wt. % or less, about 18 wt. % or less, about 17 wt. % or less, about 16 wt. % or less, about 15 wt. % or less, about 14 wt. % or less, about 13 wt. % or less, about 12 wt. % or less, about 11 wt. % or less, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less or any range or value therein between.

In some embodiments, the particle removal agent (e.g., protic organic acid) has at least one, at least two, at least 3, at least 4, at least 5, at least 6, at least 7, at least 8, or greater, dissociated complexing functional groups. In some embodiments, the particle removal agent (e.g., protic organic acid) has 10 or less, 9 or less, 8 or less, 7 or less, 6 or less, 5 or less, 4 or less, or 3 or less complexing functional groups. In the present disclosure, the “dissociated complexing functional group” refers to a proton donating group having an unshared electron pair. Examples of the dissociated complexing functional group include a phosphate group, a phosphonate group, a carboxy group (or carboxylic acid group), and a sulfo group. Among these, a phosphate group is preferable from the viewpoint of adsorption to particles (e.g., comprising ceria or zirconia). In other words, the particle removal agent preferably contains at least one phosphate group (—O—P(═O)(OH)₂) or a phosphonate group (—P(═O)(OH)₂). Only one or two or more of these groups may be contained in one molecule, in any combination of different types (e.g., phosphate, carboxyl, and/or sulfo). The phosphonate group is also called phosphonic acid group.

### Surfactant

In some embodiments, a composition according to the present disclosure comprises one or more surfactants. In some embodiments, the surfactants may comprise, consist essentially of, or consist of cationic surfactants, anionic surfactants, non-ionic surfactants, or any combination thereof. In some embodiments, the one or more surfactants comprise(s) an anionic surfactant.

In some embodiments, the surfactant may comprise one or more compounds represented by the following formula (I):

CₘH₂ₘ₊₁—(OCH₂CH₂)ₙ-L-R (I),

where 6≤m≤20, n≥5, L represents an —O—, —S—R¹—, —S—R¹— or —O—R¹— bond (where R¹ represents C₁₋₄ alkylene), and R represents an anionic group. In some embodiments, the anionic group may be a sulfonic acid group (or sulfonate), a carboxylic acid group (or carboxylate), phosphonic acid group (or phophonate), or any other suitable anionic group. In some embodiments, R is a carboxylic acid group (—COOH).

In Formula (I), m represents the number of carbon atoms in the terminal alkyl group and is an integer 6 or more and 20 or less. In some embodiments, m is 6, 7, 8, 9, 10, 11, 12, 13, 14, 15, 16, 17, 18 19 or 20. In some embodiments, m may be 7 or more and 10 or less. In some embodiments, m is 8. It is not preferable that m is less than 6 since the hydrophilicity is enhanced and the particle removal performance may be insufficient. It is not preferable that m is more than 20 since the hydrophobicity is enhanced and the particle removal performance may be insufficient.

In some embodiments, in Formula (I), n (the number of moles of ethylene oxide added) is an integer 5 or more (e.g., 5, 6, 7, 8, 9, 10, 11, or 12). In some embodiments, n is 5 or more and 12 or less, 6 or more and 12 or less, 7 or more and 12 or less, 8 or more and 12 or less, 6 or more and 11 or less, 7 or more and 11 or less, 8 or more and 11 or less, 7 or more and 10 or less, or 8 or more and 10 or less, or any range or value therein between. In some embodiments, n is 8. In some embodiments, it is not preferable that n is less than 5 since the hydrophobicity is enhanced and the particle removal performance may be insufficient. The upper limit of n is not particularly limited, but it is not preferable that the upper limit of n is more than 12 since the hydrophilicity is enhanced and the particle removal performance may be insufficient.

In some embodiments, in Formula (I), L represents a divalent group and is —O—, —S—, —R¹—, —S—R¹— or —O—R¹—. In a case in which L is —R¹—, —S—R¹— or —O—R¹—, R¹ represents an alkylene group having 1 to 4 carbon atoms (methylene group, ethylene group, trimethylene group, propylene group, tetramethylene group, or the like).

In some embodiments, in Formula (I), R represents an anionic group. From the viewpoint of the adsorptive power of anionic group, R is preferably at least one selected from the group consisting of a carboxy group, a sulfonate group, a phosphate group, a phophonate group, and a salt group thereof. In some embodiments, R is at least one selected from the group consisting of a carboxy group and a salt group thereof.

In some embodiments, the surfactant represented by Formula (I) is a polyoxyethylene alkylene ether carboxylic acid represented by the following Formula (II) or a salt thereof:

CₘH₂ₘ₊₁—(OCH₂CH₂)ₙ—O—CH₂—COOH (II)

CₘH₂ₘ₊₁—(OCH₂CH₂)ₙ—O—CH₂—COOH (II),

where m and n have the same definition as those discussed above regarding Formula (I). Preferred embodiments of m and n in Formula (II) are the same as those disclosed regarding Formula (I), and thus detailed description thereof is omitted here.

The surfactant represented by Formula (II) is not particularly limited, but non-limiting examples include: capryleth-6 carboxylic acid (in Formula (II), m=8, n=5) or a salt thereof; capryleth-9 carboxylic acid (in Formula (II), m=8, n=8) or a salt thereof; and the like. In some embodiments, the surfactant of Formula (II) is capryleth-9 carboxylic acid or a salt thereof. In some embodiments, capryleth-9 carboxylic acid is preferable from the viewpoint of particle removal performance. Only one kind of these compounds may be used singly, or two or more kinds thereof may be used in combination.

In some embodiments, the surfactant is present in the composition at a concentration, relative to the total weight of the composition, of at least about 0.001 wt. %, at least about 0.002 wt. %, at least about 0.003 wt. %, at least about 0.004 wt. %, at least about 0.005 wt. %, at least about 0.006 wt. %, at least about 0.007 wt. %, at least about 0.008 wt. %, at least about 0.009 wt. %, at least about 0.01 wt. %, at least about 0.02 wt. %, at least about 0.03 wt. %, at least about 0.04 wt. %, at least about 0.05 wt. %, at least about 0.06 wt. %, at least about 0.07 wt. %, at least about 0.08 wt. %, at least about 0.09 wt. %, at least about 0.1 wt. % or any range or value therein between.

In some embodiments, the surfactant is present in the composition at a concentration, relative to the total weight of the composition, of about 20 wt. % or less, about 19 wt. % or less, about 18 wt. % or less, about 17 wt. % or less, about 16 wt. % or less, about 15 wt. % or less, about 14 wt. % or less, about 13 wt. % or less, about 12 wt. % or less, about 11 wt. % or less, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, about 0.5 wt. % or less, about 0.4 wt. % or less, about 0.3 wt. % or less or any range or value therein between.

In some embodiments (e.g., wherein the surfactant is a polyoxyethylene alkyl ether carboxylic acid), the surfactant has a hydrophilic-lipophilic balance (HLB) value, as determined by the Davies method, of 2 or more, 3 or more, 4 or more 5 or more 6 or more, 7 or more, 7.2 or more, 7.5 or more, 7.8 or more, 8 or more, 8.2 or more, 8.5 or more, 8.8 or more, 9 or more, 9.2 or more, 9.5 or more, 9.8 or more, 10 or more, 10.5 or more, 11 or more, 11.5 or more, 12 or more, 12.5 or more, 13 or more, 13.5 or more, 14 or more, 14.5 or more, 15 or more, or any range or value therein between. In some embodiments, the surfactant (e.g., polyoxyethylene alkyl ether carboxylic acid) has an HLB value of 7 or more, 7.2 or more, 7.5 or more, 7.8 or more, or 8 or more. In some embodiments, the surfactant (e.g., polyoxyethylene alkyl ether carboxylic acid) has an HLB value of 20 or less, 19 or less, 18 or less, 17 or less, 16 or less, 15 or less, 14 or less, 13 or less, 12 or less, 11, or less, 10 or less, 9 or less, 8 or less, or any range or value therein between. In the present specification, the hydrophilic-lipophilic balance (HLB) value by Davies method is determined by the relationship (Equation 5):¹ ¹Equation (5) is a simplified version of the following equation for HLB, which may also be used in some embodiments:

HLB=7+total number of hydrophilic groups−total number of lipophilic groups (5)

See J.T. Davis, Proc. Int'l Congr. Surface Activity, at 426 (2d ed. 1957).

HLB=7+Σᵢ₌₁^{m} Hᵢ−n×0.475, [Expression 1]

where m=number of hydrophilic groups in the molecule; Hᵢ=value of the i^{th} hydrophilic groups; and n=number of lipophilic groups in the molecule. See Hydrophilic-Lipophilic Balance, Wikipedia (Jan. 19, 2020), https://en.wikipedia.org/wiki/Hydrophilic-lipophilic_balance.

### Base

In some embodiments, a composition according to the present disclosure comprises a base. In some embodiments, the base may comprise an organic amine compound. In some embodiments, the organic amine compound is a non-aromatic amine compound (i.e., does not comprise an aromatic ring). In some embodiments, the organic amine compound may comprise a hydroxy group, an alkoxy group, a thiol group, or any combination thereof. In some embodiments, one or more bases may be present.

In some embodiments, the base comprises an alkylated amine. In some embodiments, the base comprises alkylated amine with a hydroxy group. In some embodiments, the alkyl in the alkylated amine (alkylated amine with a hydroxy group) has 3 to 15, 4 to 14, 5 to 13, 6 to 12, 7 to 11, or 8 to 10 carbon atoms.

The organic amine compound is not particularly limited, but examples include 2-(diethylamino)ethanethiol, captamine, diethylethanolamine, methylcysteamine, 2-(tert-butylamino)ethanethiol, 2,2′-dimethoxy-1,1-dimethyl-dimethylamine, 3-amino-4-octanol, 3-butoxypropylamine, N-acetylcysteamine, homocysteamine, N,N-dimethylhydroxylamine, 2-(isopropylamino)ethanol, 2-(methylthioethyl)amine, 1-aminopropane-2-thiol, leucinol, cysteamine, and N,O-dimethylhydroxylamine. In some embodiments, the base is at least one selected from the group consisting of: 2-(diethylamino)ethanethiol; captamine; 3-amino-4-octanol; cysteamine; N,N-dimethylhydroxylamine; and N,O-dimethylhydroxylamine. In some embodiments, the base is at least one selected from the group consisting of: 2-(diethylamino)ethanethiol; captamine; and 3-amino-4-octanol. In some embodiments, the base is 3-amino-4-octanol. A single base may be used, or two or more bases may be used in combination in the cleaning composition.

In some embodiments, the base is present in the composition at a concentration, relative to the total weight of the composition, of at least about 0.001 wt. %, at least about 0.002 wt. %, at least about 0.003 wt. %, at least about 0.004 wt. %, at least about 0.005 wt. %, at least about 0.006 wt. %, at least about 0.007 wt. %, at least about 0.008 wt. %, at least about 0.009 wt. %, at least about 0.01 wt. %, at least about 0.02 wt. %, at least about 0.03 wt. %, at least about 0.04 wt. %, at least about 0.05 wt. %, at least about 0.06 wt. %, at least about 0.07 wt. %, at least about 0.08 wt. %, at least about 0.09 wt. %, at least about 0.1 wt. %, at least about 0.2 wt. %, at least about 0.3 wt. %, at least about 0.4 wt. %, at least about 0.5 wt. % or any range or value therein between.

In some embodiments, the base is present in the composition at a concentration, relative to the total weight of the composition, of about 20 wt. % or less, about 19 wt. % or less, about 18 wt. % or less, about 17 wt. % or less, about 16 wt. % or less, about 15 wt. % or less, about 14 wt. % or less, about 13 wt. % or less, about 12 wt. % or less, about 11 wt. % or less, about 10 wt. % or less, about 9 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, about 0.9 wt. % or less, about 0.8 wt. % or less, about 0.7 wt. % or less, about 0.6 wt. % or less, or any range or value therein between.

### pH of Composition

In some embodiments, the pH of the composition is acidic (e.g., less than 7). In some embodiments, the pH of the composition is less than 7, less than or equal to 6.9, less than or equal to 6.8, less than or equal to 6.7, less than or equal to 6.6, less than or equal to 6.5, less than or equal to 6.4, less than or equal to 6.3, less than or equal to 6.2, less than or equal to 6.1, less than or equal to 6.0, less than or equal to 5.9, less than or equal to 5.8, less than or equal to 5.7, less than or equal to 5.6, less than or equal to 5.5, less than or equal to 5.4, less than or equal to 5.3, less than or equal to 5.2, less than or equal to 5.1, less than or equal to 5.0, less than or equal to 4.9, less than or equal to 4.8, less than or equal to 4.7, less than or equal to 4.6, less than or equal to 4.5, less than or equal to 4.4, less than or equal to 4.3, less than or equal to 4.2, less than or equal to 4.1, less than or equal to 4.0, less than or equal to 3.9, less than or equal to 3.8, less than or equal to 3.7, less than or equal to 3.6, less than or equal to 3.5, less than or equal to 3.4, less than or equal to 3.3, less than or equal to 3.2, less than or equal to 3.1, less than or equal to 3.0, less than or equal to 2.9, less than or equal to 2.8, less than or equal to 2.7, less than or equal to 2.6, less than or equal to 2.5, less than or equal to 2.4, less than or equal to 2.3, less than or equal to 2.2, less than or equal to 2.1, less than or equal to 2.0, or any range or value therein between.

In some embodiments, the pH of the composition is greater than or equal to 1.0, greater than or equal to 1.1, greater than or equal to 1.2, greater than or equal to 1.3, greater than or equal to 1.4, greater than or equal to 1.5, greater than or equal to 1.6, greater than or equal to 1.7, greater than or equal to 1.8, greater than or equal to 1.9, greater than or equal to 2.0, greater than or equal to 2.1, greater than or equal to 2.2, greater than or equal to 2.3, greater than or equal to 2.4, greater than or equal to 2.5, greater than or equal to 2.6, greater than or equal to 2.7, greater than or equal to 2.8, greater than or equal to 2.9, greater than or equal to 3.0, greater than or equal to 3.1, greater than or equal to 3.2, greater than or equal to 3.3, greater than or equal to 3.4, greater than or equal to 3.5, greater than or equal to 3.6, greater than or equal to 3.7, greater than or equal to 3.8, greater than or equal to 3.9, greater than or equal to 4.0, greater than or equal to 4.1, greater than or equal to 4.2, greater than or equal to 4.3, greater than or equal to 4.4, greater than or equal to 4.5, greater than or equal to 4.6, greater than or equal to 4.7, greater than or equal to 4.8, greater than or equal to 4.9, greater than or equal to 5.0, greater than or equal to 5.1, greater than or equal to 5.2, greater than or equal to 5.3, greater than or equal to 5.4, greater than or equal to 5.5, greater than or equal to 5.6, greater than or equal to 5.7, greater than or equal to 5.8, greater than or equal to 5.9, greater than or equal to 6.0, or any range or value therein between.

In some embodiments, the pH of the composition is from 2 to 6, from 2 to 5, from 2 to 4, from 2 to 3, from 3 to 6, from 3 to 5, from 3 to 4, from 4 to 6, from 4 to 5, or from 5 to 6. In some embodiments, the pH of the composition is about 3.

The pH value in the present specification is determined using a pH meter (e.g., LAQUA® manufactured by HORIBA, Ltd., or any other suitable pH meter).

### pH Adjusting Agent

In some embodiments, a composition according to the present disclosure may further comprise one or more pH adjusting agents to adjust the pH to a desired pH value. In some embodiments, the “surfactant”, “particle removal agent,” “base” (e.g., “organic amine compound”), and “reducing agent” described above are not considered to be pH adjusting agent(s).

The pH adjusting agent is not particularly limited, and any suitable pH adjusting agent may be used to bring the pH of the composition into any desired range, as discussed above. In some embodiments, the one or more pH adjusting agents may comprise, consist essentially of, or consist of an inorganic compound, an organic compound, or combinations thereof. In some embodiments, the one or more pH adjusting agents may comprise inorganic acids (e.g., hydrochloric acid, hydrobromic acid, hydroiodic acid, sulfuric acid, nitric acid, boric acid, carbonic acid, hypophosphorous acid, phosphorous acid, and phosphoric acid); organic acids (e.g., carboxylic acids such as formic acid, acetic acid, propionic acid, benzoic acid, salicylic acid, glyceric acid, oxalic acid, malonic acid, succinic acid, maleic acid, phthalic acid, malic acid, tartaric acid, and lactic acid); and/or organic sulfuric acids (e.g., methane sulfonic acid, ethane sulfonic acid, isethionic acid, etc.). In some embodiments, the one or more pH adjusting agents may comprise a divalent or higher acid of the above acid(s) (e.g., sulfuric acid, carbonic acid, phosphoric acid, oxalic acid, etc.), which may be in the form of a base when one or more protons (H⁺) can be released (e.g., ammonium hydrogen carbonate or ammonium hydrogen phosphate), but any counter-ion may be used (e.g., weakly basic cations, such as ammonium, triethanolamine, etc.).

In some embodiments, the one or more pH adjusting agents may comprise one or more hydroxides of alkali metals (e.g., NaOH, KOH), or salts thereof (e.g., carbonates, hydrogen carbonates, sulfates, acetates, etc.); quaternary ammonium compounds (e.g., tetramethylammonium, tetraethylammonium, tetrabutylammonium, etc.); quaternary ammonium hydroxides (e.g., tetramethylammonium hydroxide, tetraethylammonium hydroxide, tetrabutylammonium hydroxide) or a salts thereof; ammonia; amines; or any other suitable pH adjusting agent.

The pH adjust agent may be present in any amount suitable to achieve a desired pH value, as discussed above.

### Other Additives

In some embodiments, the composition may comprise other additives at any concentration. However, it is desirable not to add unnecessary components, which may cause the presence of defects or pad stains. Thus, it is preferred that any other additives are present in relatively small concentrations, if they are present at all. Examples of other additives include wetting agents, antiseptic agents, dissolved gases, oxidizing agents, and the like.

In some embodiments, the composition does not comprise polymer particles. In some embodiments, the composition does not comprise a sulfate surfactant. In some embodiments, the composition does not substantially comprise polymer particles. In some embodiments, the composition does not substantially comprise a sulfate surfactant.

### Dispersing Medium

In some embodiments, the composition comprises a dispersing medium or solvent. The dispersing medium may serve the function of dispersing or dissolving the respective components. In some embodiments, the dispersing medium comprises, consists essentially of, or consists of water. In some embodiments, the dispersing medium may be a mixed solvent (e.g., water and an organic solvent) to facilitate dispersion or dissolution of the respective components. In some embodiments, the organic solvent may comprise, consist essentially of, or consist of acetone, acetonitrile, ethanol, methanol, isopropanol, glycerin, ethylene glycol, propylene glycol, or any other suitable organic solvent. In some embodiments, the organic solvent is miscible with water. In some embodiments, one or more organic solvents may be used without being mixed with water (e.g., when the respective components may be dispersed or dissolved in the one or more organic solvents). In some embodiments, dispersions or solutions of such components in one or more organic solvents may then be mixed with water. The one or more organic solvents may be used singly or in combinations of two or more.

In some embodiments, the water is preferably water which does not contain impurities or which contains as little impurities as possible. Limiting the content of impurities may inhibit contamination of the object to be subjected to surface treatment or cleaning and/or may facilitiate more effective action of other components in the composition. For example, water in which the total content of transition metal ions is 100 ppb or less is preferable. In some embodiments, the total concentration of transition metal ions is 500 ppm or less, 400 ppm or less, 300 ppm or less, 200 ppm or less, 100 ppm or less, 900 ppb or less, 800 ppb or less, 700 ppb or less, 600 ppb or less, 500 ppb or less, 400 ppb or less, 300 ppb or less, 200 ppb or less, 100 ppb or less, 900 ppt or less, 800 ppt or less, 700 ppt or less, 600 ppt or less, 500 ppt or less, 400 ppt or less, 300 ppt or less, 200 ppt or less, or 100 ppt or less, or any range or value therein between. Here, the purity of water can be increased by, e.g., removal of impurity ions using one or more ion exchange resins, removal of foreign matter using one or more filters, distillation, and/or other operations. In some embodiments, the water is deionized water (e.g., ion-exchanged water), distilled water, pure water, ultrapure water, or the like.

Methods for Simultaneous Removing a Pad Stain From a Polishing Pad and Removing Particles From a Polished Surface

In another aspect, the present disclosure relates to a method for simultaneously removing a pad stain from a polishing pad and removing particles from a polished surface after polishing, the method comprising: supplying a cleaning composition for post-CMP cleaning of a surface according the above disclosure to the polished surface; and contacting the polished surface with the polishing pad in the presence of the cleaning composition for post CMP-cleaning to produce a polished surface having a reduced defect count.

In some embodiments, the polished surface is a semiconductor surface (e.g., carbon (e.g., PCVD (Plasma-Enhanced Chemical Vapor Deposition) carbon) Si, doped Si, TiO₂, GaAs, etc.). In some embodiments, the semiconductor surface includes patterned metal wiring of copper, tungsten, etc. In some embodiments the polished surface has been polished using a CMP composition comprising abrasive particles (e.g., silica, aluminia, ceria, zirconia, titania, etc.). In some embodiments the polished surface has been polished using a CMP composition comprising a polishing rate accelerator (e.g., KMnO₄).

In some embodiments, supplying a cleaning composition of the present disclosure to a polished surface affords a surface with a reduced defect count. In some embodiments, the reduced defect count is less than 500, less than 450, less than 400, less than 350, less than 300, less than 250, less than 220, less than 200, less than 190, less than 180, less than 170, less than 160, less than 150, less than 140, less than 130, less than 120, less than 110, less than 100, less than 90, less than 80, less than 70, less than 60, less than 50, less than 40, less than 30, less than 20, less than 10, less than 9, less than 8, less than 7, less than 6, less than 5, less than 4, less than 3, less than 2, less than, or 0, or any range or value therein between.

In some embodiments, contacting the polished surface with the polishing pad in the presence of the cleaning composition removes a pad stain left by contact of the polishing pad with a CMP composition comprising a polishing rate accelerator (e.g., KMnO₄). In some embodiments, the pad stain comprises manganese oxides (e.g., MnO₂). In some embodiments, contacting the polished surface with the polishing pad removes the pad stain. Preferably, contacting the polished surface with the polishing pad completely removes the pad stain.

In some embodiments, the contacting is performed for at least 1 second, at least 2 seconds, at least 3 seconds, at least 4 seconds, at least 5 seconds, at least 6 seconds, at least 7 seconds, at least 8 seconds, at least 9 seconds, at least 10 seconds, at least 15 seconds, at least 20 seconds, at least 25 seconds, at least 30 seconds, at least 35 seconds, at least 40 seconds, at least 45 seconds, at least 50 seconds, at least 55 seconds, at least 60 seconds, at least75 seconds, at least 90 seconds, at least 100 seconds, at least 120 seconds, at least 150 seconds, at least 180 seconds, at least 5 minutes, at least 10 minutes, at least 15 minutes, at least 20 minutes, at least 25 minutes, at least 30 minutes, at least 35 minutes, at least 40 minutes, at least 45 minutes, at least 50 minutes, at least 55 minutes, at least 60 minutes, or any range or value therein between.

In some embodiments, the cleaning composition does not substantially comprise abrasive grains (particles). Examples of the abrasive grains or particle include foregoing ones. In the present specification, “not substantially comprising” means that the composition may contain 100 ppm by weight or less, 50 ppm by weight or less, or 10 ppm by weight or less of the corresponding component. Examples of the abrasive grains (particles) include, as described above, inorganic particles and organic particles. Specific examples of inorganic particles include metal oxide particles such as silica, alumina, ceria, titania, and zirconia, silicon nitride particles, silicon carbide particles, and boron nitride particles. Specific examples of organic particles include polymethyl methacrylate (PMMA) particles.

While the foregoing terms are believed to be well understood by one of ordinary skill in the art, the following definitions are set forth to facilitate explanation of the presently disclosed subject matter.

The term “a” or “an” may refer to one or more of that entity, i.e. can refer to plural referents. As such, the terms “a” or “an”, “one or more” and “at least one” are used interchangeably herein. In addition, reference to “an element” by the indefinite article “a” or “an” does not exclude the possibility that more than one of the elements is present, unless the context clearly requires that there is one and only one of the elements.

Reference throughout this specification to “one embodiment”, “an embodiment”, “one aspect”, or “an aspect” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

As used herein, the terms “about” or “approximately” when preceding a numerical value indicates the value plus or minus a range of 10% of the value.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. While not explicitly defined below, such terms should be interpreted according to their common meaning.

In addition, where features or aspects of the disclosure are described in terms of Markush groups, those skilled in the art will recognize that the disclosure is also thereby described in terms of any individual member or subgroup of members of the Markush group.

Unless the context indicates otherwise, it is specifically intended that the various features of the invention described herein can be used in any combination. Moreover, the disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Unless explicitly indicated otherwise, all specified embodiments, features, and terms intend to include both the recited embodiment, feature, or term and equivalents thereof.

All patents, patent applications, provisional applications, and publications referred to or cited herein are incorporated by reference in their entirety, including all figures and tables, to the extent they are not inconsistent with the explicit teachings of this specification.

Reference will now be made in detail to some specific embodiments contemplated by the present disclosure. While various embodiments are described herein, it will be understood that it is not intended to limit the present technology to the described embodiments. On the contrary, it is intended to cover alternatives, modifications, and equivalents as may be included within the spirit and scope of the technology as defined by the appended claims.

### EXAMPLE 1

Removal of MnO₂ Pad Stain by Cleaning Formulation with Reducing Agent or Like Agent and Particle Removal Agent

Preparation of Cleaning Composition.

To test the effectiveness of cleaning compositions according to the present disclosure in removing MnO₂ pad stains, the following cleaning composition was prepared by adding the listed ingredients to deionized water. In this composition (“Composition A”), the reducing agent was ascorbic acid, the particle removal agent was HEDP, the surfactant was capryleth-9-carboxylic acid, and the base was 3-amino-4-octanol. The cleaning composition is shown below in Table 1.

TABLE 1
Composition A

| Component | POU wt-% |
|---|---|
| 1-hydroxyethylidene-1,1-diphosphonic acid | 0.555 |
| 3-amino-4-octanol | 0.515 |
| capryleth-9 carboxylic acid | 0.22 |
| ascorbic acid | 0.806 |
| DI Water | Remainder |

Pad Stain Removal

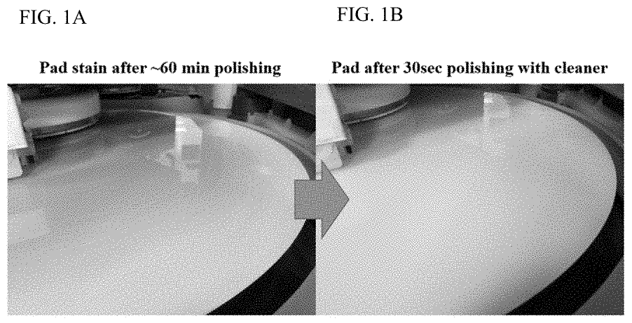

Metal-based oxidizers (e.g., KMnO₄) can allow for higher removal rates over traditional non-metal oxidizers (e.g., H₂O₂). However, the use KMnO₄ is limited due to the formation of by-product MnO₂, which stains the polishing pad and increases post-CMP defect counts significantly. FIG. 1A shows a IC1010 pad after approximately 60 minutes of polishing with a KMnO₄-containing slurry (colloidal zirconia (average secondary particle size: 70 nm): 0.5 wt. %, KMnO₄: 0.3 wt. %, pH: 3.0). Polishing conditions (polishing parameters), except polishing time, at that time are as shown in Table 4. X-ray photoelectron spectroscopy (XPS) was performed on a section of the stained pad to confirm the chemical composition of the pad stain. As shown in Table 2, peak fitting analysis of the Mn 2p_{3/2} peak shows the presence of manganese oxides. The table shows peak components characteristic of MnO-containing species at binding energies of 640.7 eV, 642.1 eV, and 644.0 eV. (These peaks appear at higher binding energies than Mn 2p_{3/2} from Mn metal, which has a characteristic binding energy of approximately 638.5 eV). Average secondary particle size can be measured, e.g., by dynamic light scattering, a representative example of which is laser diffraction scattering. Specifically, the average secondary particle size of abrasive grains corresponding to the particle diameter at which cumulative particle mass as accumulated from fine particles reaches 50% of the total mass of the particles, D50, in the particle size distribution of the abrasive grains as determined by laser diffraction scattering.

TABLE 2
Mn 2p_{3/2} XPS Binding Energies for Mn-Containing Pad Stain

| Binding Energy(eV) | Species | Composition |
|---|---|---|
| 640.72 | MOₓ | 30.64% |
| 642.16 | MO_{y} | 53.72% |
| 644.01 | MOH or MO_{z} | 15.64% |

As shown in FIG. 1B, this MnOₓ-containing pad stain can be removed by on-platen rinse cleaning for thirty seconds using Composition A. Cleaning conditions (polishing parameters), except polishing time, at that time are as shown in Table 4. Without being bound by any particular theory, is it possible that the presence of a reducing agent or the like generates soluble Mn²⁺ ions which can be rinsed away from the pad.

### SP1 Defect Removal

Further, cleaning compositions according to the present disclosure were screened for the ability to remove defects from a polished PCVD (Plasma-Enhanced Chemical Vapor Deposition) carbon wafer polished with KMnO₄-containing slurry. The carbon wafer is a 300 mm PCVD carbon BTW (Blanket Test Wafer). Polishing conditions (polishing parameters) at that time are as shown in Table 4.

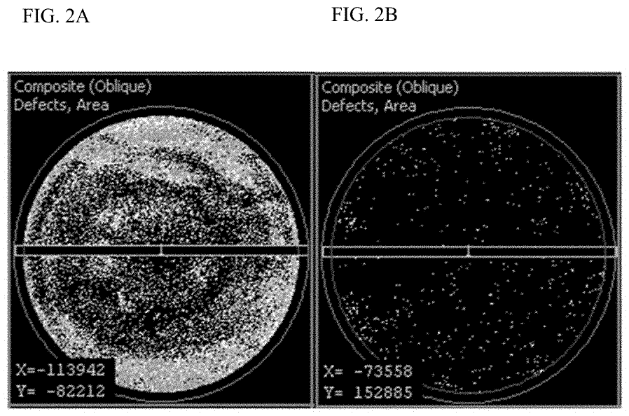

After polishing with a KMnO₄-containing slurry, SP1 defect maps were generated from the wafer surface using a KLA-Tencor SP1 surface analysis system (“SP1”). The name (model number) of SP1 was Surfscan SP1. As shown in FIG. 2A, it was found that an ammonia rinse clean of the wafer, Comparative Example of the present invention, yielded a huge number of defects. The ammonia rinse had the composition listed in Table 5.

In contrast, referring to FIG. 2B, it was found that a wafer cleaned by the Cleaning Composition A with on-platen rinse and a subsequent wafer rinse clean yielded fewer defects than ammonia cleaning yielded. This is demonstrated also in Table 5. Referring to the Composition B, use of an appropriate reducing agent in the cleaning composition (even in the absence of a particle removal agent or the like) can remove the pad stain to some degree and reduce defects, as compared to an ammonia rinse clean that is unable to remove the pad stain.

### EXAMPLE 2

Ascorbic acid in the Composition A in Example 1 was replaced with another reducing agent or the like to prepare Compositions B to G, which were subjected to the same evaluation as in Example 1. For some of the candidate reducing agents and the like, the names, standard reduction potential (E^{o}) values, and anticipated pad stain removal ability are summarized in Table 3 below.

TABLE 3
Reducing Agents, Reduction Potentials, and Expected Stain Removal Ability

| | Chemical | | | Expected |
|---|---|---|---|---|
| Reducing Agent | Formula | E°(V) | Reaction | Results |
| hydroxylamine | NH₂OH | −3.04 | N₂(g) + 4H₂O + 2e⁻ [symbol] 2NH₂OH(aq) + OH⁻ | MnO₂ stain |
| oxalic acid | C₂H₂O₄ | −0.43 | 2CO₂(g) + 2H⁺ + 2e⁻ [symbol] HOOCCOOH(aq) | removed by |
| sodium sulfite | Na₂SO₃ | 0.2 | SO₄²⁻ + 2H⁺ + 2e⁻ [symbol] SO₃²⁻(aq) + H₂O | reducing agent |
| ascorbic acid | C₆H₈O₆ | 0.39 | C₆H₆O₆ + 2e⁻ + 2H⁺ [symbol] C₆H₈O₆ | |
| hydrogen | H₂O₂ | 0.7 | H₂O₂(aq) + 2H⁺ + 2e⁻ [symbol] 2H₂O₂(aq) | |
| peroxide | | | | |
| Slurry component | KMnO₄ | 1.7 | MnO₄⁻ + 4H⁺ + 3e⁻↔MnO₂(s) + 2H₂O | MnO₂ stain |
| reaction | | | | produced |
| Polishing | MnO₂ | 1.224 | MnO₂(s) + 4H⁺ + 2e⁻ [symbol] Mn²⁺ + 2H₂O | Reduction |
| byproduct | | | | potential |
| | | | | required for |
| | | | | MnO₂ stain |
| | | | | removal |

The reducing agents shown in Table 3 were screened for their ability to remove MnOₓ pad stains, in combination with additional cleaning components to reduce defect counts to a more desirable level of, e.g., less than 100. The defect count used herein refers to SP1 defect count.

Note that the SP1 defect count is a value indicated by an output of SP1 while the total particle defect count is a value obtained by, after SP1 measurement, reviewing 200 defects selected by Review SEM for defect measurement (manufactured by Hitachi High-Tech Corporation; RS-4000) and multiplying the SP1 defect count by a proportion of number of particles among them.

The test conditions are shown in Table 4. The formulations tested are shown in Table 5. All cleaning compositions were formulated at pH 3.0±0.5 at PoU. (Some variation in pH was allowed as additional pH adjusters were not added to the formulations.) The reducing agents (except for H₂O₂) were used in equal amounts, by weight percent, across all compositions tested. In the case of H₂O₂, the reducing agent was used at 3 wt. %, added at PoU. Hydrogen peroxide (H₂O₂) was in the form of aqueous solution, and the concentration was 30 vol. %.

TABLE 4
Conditions for polishing an object with KMnO₄-containing slurry,
conditions for subsequently rinsing the polished object with
composition A, and conditions for subsequent first and second
cleaning stages for the rinsed object with composition A

| | Polisher | | | | |
|---|---|---|---|---|---|
| | REFLEXION LK (APPLIED MATERIALS) | | | | |
| Platen | | Platen 2 | | Platen 3 On Platen buffing | |
| Consumables | Polishing | KMnO₄-slurry | | — | |
| | agent | (0.5 wt % colloidal zirconia | | | |
| | | (average secondary particle | | | |
| | | size 70 nm), pH: 3.0, KMnO₄: | | | |
| | | 0.3 wt %) | | | |
| | Rinsing agent | — | | Composition A | |
| Polishing | Polishing pad | IC1010 (Rodel Inc.) | | | |
| parameters | Platen speed | 100 | rpm | 60 | rpm |
| | Head speed | 94 | rpm | 54 | rpm |
| | Polishing | 3.0 | psi | 1.0 | psi |
| | pressure | | | | |
| | Flow rate | 200 | ml/min | 250 | ml/min |
| | (Polishing | | | | |
| | agent or | | | | |
| | rinsing agent) | | | | |
| | Polishing time | 60 | sec | 15 | sec |

| | | Cleaner (Brush box) | | | |
|---|---|---|---|---|---|
| | | Brush Box 1 | | Brush Box 2 | |
| Consumables | Cleaner | Composition A | | Composition A | |
| Cleaning | Flow rate | 2000 | mL/min | 2000 | mL/min |
| parameters | Brush time | 30 | sec | 30 | sec |

Platen 2 was used to polish a PCVD carbon BTW (Blanket Test Wafer) surface with the above polishing agent using the above polishing parameters. Thereafter, the wafer was moved to Platen 3, and rinsed (cleaned)with the above polishing parameters using composition A. Thereafter, the wafer was moved to Cleaner 1 (Brush Box 1) and cleaned with composition A while a surface of the wafer was rubbed with a roller-type PVA sponge using the above cleaning parameter. Thereafter, the wafer was moved to Cleaner 2 (Brush Box 2) and cleaned with composition A while the surface of the wafer was rubbed with a roller-type PVA sponge using the above cleaning parameter.

After being polished, the wafer may be cleaned (rinsed) on the platen; however, in a particularly preferred embodiment, thereafter, it is further cleaned by a brush box (cleaner). The cleaning with the brush box (cleaner) may be performed several times as described above.

A defect count on the surface of a 300 mm PCVD carbon (carbon film formed by plasma CVD method) BTW (Blanket Test Wafer) was measured after using compositions shown in Table 5 under polishing and cleaning conditions shown in Table 4.

TABLE 5
Evaluation on MnO₂ pad stain removal and defect reduction when reducing agent for composition A is replaced

| | | Ammonia (0.3 | | | | | | | |
|---|---|---|---|---|---|---|---|---|---|
| | | wt. % ammonia | | | | | | | |
| Composition | | aqueous solution) | A | B | C | D | E | F | G |
| Reducing Agent | | N/A | Ascorbic | Ascorbic | Hydroxyl | Oxalic | Sodium | Sodium | Hydrogen |
| | | | acid | acid | amine | acid | sulfite | hypophosphite | peroxide |
| MnO₂ Pad Stain Removed? | | No | Yes | Yes | Yes | Yes | Yes | Yes | Yes |
| Total SP1 Defect Count | | 1751 | 17 | 681 | 237 | 44 | 111 | 70 | 47 |
| Total Particle Defect Count | | 1751 | 0 | 136 | 0 | 2 | 0 | 0 | 1 |
| Stability of Composition | | n/a | Good | Good | Good | Fair | Good | Good | Excellent |
| Component | 1-hydroxyethylidene-1,1- | — | 0.555 | — | 0.555 | 0.555 | 0.555 | 0.555 | 0.555 |
| wt. % at | diphosphonic acid | | | | | | | | |
| PoU | 3-amino-4-octanol | — | 0.515 | — | 0.515 | 0.515 | 0.515 | 0.515 | 0.515 |
| | Capryleth-9carboxylic acid | — | 0.22 | — | 0.22 | 0.22 | 0.22 | 0.22 | 0.22 |
| | Reducing Agent | — | 0.806 | 0.806 | 0.806 | 0.806 | 0.806 | 0.806 | 3 |
| | DI water | — | Remainder | Remainder | Remainder | Remainder | Remainder | Remainder | Remainder |
| | Total | 100 | 100 | 100 | 100 | 100 | 100 | 100 | 100 |

* Evaluation method for stability of compositions
Evaluation method
Each composition was allowed to stand for 3 days, and a difference of pH after a lapse of 3 days was measured.
Specifically, |pH (3 days later) − pH (immediately after production)| was calculated.
Criteria for judgement:
Excellent: less than 0.1
Good: 0.1 or more and less than 0.2
Fair: 0.2 or more and less than 0.5
Poor: 0.5 or more
* Total SP1 defect count refers to a defect count on a 300-mm wafer

As evidenced in Table 5, all reducing agents screened were able to remove the MnO₂ pad stain, when compared to ammonia. Further, as evidenced by the results for Compositions A to G, all reducing agents were able to reduce the total SP1 defect counts, relative to the defect counts observed for ammonia. The efficacy of particle removal agents is highlighted by comparing the results for Composition B (ascorbic acid only; no particle removal agent) with Composition A (ascorbic acid+particle removal agent). Although Composition B was able to reduce the total SP1 defect count and total defect count to 681 and 136, respectively, Composition A including a particle removal agent, was able to further reduce the total SP1 defect count and total defect count to 17 and 0, respectively. Thus, the presence of ascorbic acid and a particle removal agent essentially eliminates total defect counts.

While certain embodiments have been illustrated and described, it should be understood that changes and modifications may be made therein in accordance with ordinary skill in the art without departing from the technology in its broader aspects as defined in the following claims.

The compositions and methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof It is recognized that various modifications are possible within the scope of the disclosure claimed. Thus, it should be understood that although the present disclosure has been specifically disclosed by preferred embodiments and optional features, modification and variation of the disclosure embodied therein herein disclosed may be resorted to by those skilled in the art, and that such modifications and variations are considered to be within the scope of this disclosure.

The disclosure has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein. The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions or biological systems, which can, of course, vary. It is also to be understood that the terminology used herein is for the purpose of describing particular embodiments only, and is not intended to be limiting.

One skilled in the art readily appreciates that the present disclosure is well adapted to carry out the objects and obtain the ends and advantages mentioned, as well as those inherent therein. Modifications therein and other uses will occur to those skilled in the art. These modifications are encompassed within the spirit of the disclosure and are defined by the scope of the claims, which set forth non-limiting embodiments of the disclosure.

In addition, where features or aspects of the disclosure are described in terms of Markush groups, those skilled in the art will recognize that the disclosure is also thereby described in terms of any individual member or subgroup of members of the Markush group.

All references, articles, publications, patents, patent publications, and patent applications cited herein are incorporated by reference in their entireties for all purposes. However, mention of any reference, article, publication, patent, patent publication, and patent application cited herein is not, and should not be taken as, an acknowledgment or any form of suggestion that they constitute valid prior art or form part of the common general knowledge in any country in the world.

Other embodiments are set forth in the following claims.

This application is based on US Provisional Patent Application No. 63/248,067, filed Sep. 24, 2021, the disclosure of which is incorporated herein by reference in its entirety.

The invention includes the following aspects and forms.

1. A cleaning composition for post-CMP cleaning of semiconductor surfaces, comprising: one or more reducing agents; a particle removal agent; a surfactant; and a base.

2. The cleaning composition of 1, wherein the one or more reducing agents yield a standard reduction potential (E^{o}) of less than 1.224 V.

3. The cleaning composition of 1 or 2, wherein the one or more reducing agents comprise at least one selected from sulfites, dithionates, thiosulfates, iodides, phosphites, hypophosphites, formic acid, phosphorous acid, ascorbic acid, hydrogen peroxide, hydroxylamine, oxalic acid, sodium sulfite, alkali salts thereof, or any combination thereof.

4. The cleaning composition of any one of 1 to 3, wherein the reducing agent comprises at least one selected from ascorbic acid and hydrogen peroxide.

5. The cleaning composition of any of 1 to 4, wherein the one or more reducing agents are present at a concentration of 0.01 to 10 wt. %, relative to the total weight of the composition.

6. The cleaning composition of any one of 1 to 5, wherein the one or more reducing agents are present at a concentration of 0.1 to 1 wt. %, relative to the total weight of the composition.

7. The cleaning composition of any one of 1 to 6, wherein the particle removal agent comprises glycine, N-(phosphonomethyl) iminodiacetic acid hydrate, hydroxyphosphonoacetic acid, citric acid, hydroxyethane-1,1-diphosphonic acid and 2-phosphonobutane-1,2,4-tricarboxylic acid, or 1-hydroxyethylidene-1,1-diphosphonic acid (HEDP).

8. The cleaning composition of any one of 1 to 7, wherein the particle removal agent comprises a compound represented by N(R¹)(R²)(R³) or a salt thereof, or a compound represented by C(R¹)(R²)(R³)(R⁴) or a salt thereof, wherein R¹ to R³ and R¹ to R⁴ each independently represent a hydrogen atom, a carboxyl group, a hydroxyl group, a phosphonic acid group or a salt group thereof, or a substituted or unsubstituted linear or branched alkyl group having 1 or more and 5 or less carbon atoms, where one or more of R¹ to R³ are each a phosphonic acid group or a salt group thereof, or an alkyl group substituted with a phosphonic acid group or a salt group thereof, and one or more of R¹ to R⁴ are each a phosphonic acid group or a salt group thereof, or an alkyl group substituted with a phosphonic acid group or a salt group thereof.

9. The cleaning composition of any one of 1 to 8, wherein the particle removal agent comprises 1-hydroxyethylidene-1, 1-diphosphonic acid (HEDP).

10. The cleaning composition of any one of 1 to 9, wherein the particle removal agent is present at a concentration of 0.05 to 5 wt. %, relative to the total weight of the composition.

11. The cleaning composition of any one of 1 to 10, wherein the particle removal agent is present at a concentration of 0.5 to 1 wt. %, relative to the total weight of the composition.

12. The cleaning composition of any one of 1 to 11, wherein the base comprises 2-(diethylamino)ethanethiol, captamine, diethylethanolamine, methylcysteamine, 2-(tert-butylamino)ethanethiol, 2,2′-dimethoxy-1,1-dimethyl-dimethylamine, 3-amino-4-octanol, 3-butoxypropylamine, N-acetylcysteamine, homocysteamine, N,N-dimethylhydroxylamine, 2-(isopropylamino)ethanol, 2-(methylthioethyl)amine, 1-aminopropane-2-thiol, leucinol, cysteamine, and/or N,O-dimethylhydroxylamine.

13. The cleaning composition of any one of 1 to 12, wherein the base comprises an alkylated amine.

14. The cleaning composition of any one of 1 to 13, wherein the base comprises 3-amino-4-octanol.

15. The cleaning composition of any one of 1 to 14, wherein the base is present at a concentration of 0.05 to 5 wt. %, relative to the total weight of the composition.

16. The cleaning composition of any one of 1 to 15, wherein the base is present at a concentration of 0.5 to 1 wt. %, relative to the total weight of the composition.

17. The cleaning composition of any one of 1 to 16, wherein the surfactant comprises a carboxylic acid surfactant.

18. The cleaning composition of any one of 1 to 17, wherein the surfactant is represented by Formula (I):

CₘH₂ₘ₊₁—(OCH₂CH₂)ₙ-L-COOH (I),
where 6≤m≤20,
n≥5,
L is a bond, —O—, —S—, —R¹—, —S—R¹—, or —O—R¹—, where R¹ is a C₁₋₄ alkylene.

19. The cleaning composition of any one of 1 to 18, wherein the surfactant comprises capryleth-9-carboxylic acid.

20. The cleaning composition of any one of 1 to 19, wherein the surfactant is present at a concentration of 0.01 to 10 wt. %, relative to the total weight of the composition.

21. The cleaning composition of any one of 1 to 20, wherein the surfactant is present at a concentration of 0.1 to 1 wt. %, relative to the total weight of the composition.

22. The cleaning composition of any of 1 to 21,

wherein the reducing agent yields a standard reduction potential (E^{o}) of less than 1.224 V or comprises at least hydrogen peroxide;

wherein the particle removal agent comprises a compound represented by N(R¹)(R²)(R³) or a salt thereof, or a compound represented by C(R¹)(R²)(R³)(R⁴) or a salt thereof, wherein R¹ to R³ and R¹ to R⁴ each independently represent a hydrogen atom, a carboxyl group, a hydroxyl group, a phosphonic acid group or a salt group thereof, or a substituted or unsubstituted linear or branched alkyl group having 1 or more and 5 or less carbon atoms, where one or more of R¹ to R³ are each a phosphonic acid group or a salt group thereof, or an alkyl group substituted with a phosphonic acid group or a salt group thereof, and one or more of R¹ to R⁴ are each a phosphonic acid group or a salt group thereof, or an alkyl group substituted with a phosphonic acid group or a salt group thereof;

wherein the surfactant is represented by Formula (I):

CₘH₂ₘ₊₁—(OCH₂CH₂)ₙ-L-COOH (I),
where 6≤m≤20,
n≥5,
L is a bond, —O—, —S—, —R¹—, —S—R¹—, or —O—R¹—, where R¹ is a C₁₋₄ alkylene; and

wherein the base comprises an alkylated amine including a hydroxy group.

23. A cleaning composition for post-CMP cleaning of semiconductor surfaces, comprising: hydrogen peroxide; a particle removal agent; a surfactant; and a base.

24. The cleaning composition of 23 comprising: hydrogen peroxide; hydroxyethane-1,1-diphosphonic acid; capryleth-9-carboxylic acid; and 3-amino-4-octanol.

25. The cleaning composition of any one of 1 to 24, wherein the composition has a pH of 2 to 6.

26. The cleaning composition of 25, wherein the pH is about 3.

27. A method for simultaneously removing a pad stain from a polishing pad and removing particles from a semiconductor surface after polishing, comprising: supplying a cleaning composition of any one of 1 to 22 to the semiconductor surface; and contacting the semiconductor surface with the polishing pad in the presence of the cleaning composition to produce a polished semiconductor surface having a reduced defect count.

28. The method of claim 27, wherein the pad stain comprises MnO₂.

29. The method of 27 or 28, wherein the reduced defect count is 100 or less.

30. The method of any one of 27 to 29, wherein the reduced defect count is 70 or less.

31. The method of any one of 27 to 30, wherein the reduced defect count is 50 or less.

32. The method of any one of 27 to 31, wherein the reduced defect count is 20 or less.

33. The method of any one of 27 to 32, wherein after the contacting, the polished semiconductor surface has a total particle defect count of 2 or less.

34. The method of any one of 27 to 33, wherein after the contacting, the polished semiconductor surface has a total particle defect count of 0.

35. A method for polishing a semiconductor surface, comprising: polishing the semiconductor surface with a polishing composition comprising a removal rate enhancer; and simultaneously removing a pad stain from a polishing pad and removing particles from the semiconductor surface by the method of any one of 27 to 34.

36. A method for producing a polished semiconductor surface, comprising: polishing a semiconductor surface with a polishing composition comprising a removal rate enhancer; and simultaneously removing a pad stain from a polishing pad and removing particles from the semiconductor surface by the method of any one of 27 to 34.

37. The method of 35 or 36, wherein the removal rate enhancer comprises KMnO₄ and the pad stain comprises MnO₂.

What is claimed is:

1. A cleaning composition for post-CMP cleaning of semiconductor surfaces, comprising: a reducing agent; a particle removal agent; a surfactant; and a base.

2. The cleaning composition of claim 1, wherein the reducing agent comprises at least one selected from sulfites, dithionates, thiosulfates, iodides, phosphites, hypophosphites, formic acid, phosphorous acid, ascorbic acid, hydrogen peroxide, hydroxylamine, oxalic acid, sodium sulfite, alkali salts thereof, or any combination thereof.

3. The cleaning composition of claim 1, wherein the reducing agent comprises at least one selected from ascorbic acid and hydrogen peroxide.

4. The cleaning composition of claim 1, wherein the particle removal agent comprises glycine, N-(phosphonomethyl) iminodiacetic acid hydrate, hydroxyphosphonoacetic acid, citric acid, hydroxyethane-1,1-diphosphonic acid and 2-phosphonobutane-1,2,4-tricarboxylic acid, or 1-hydroxyethylidene-1,1-diphosphonic acid (HEDP).

5. The cleaning composition of claim 1, wherein the particle removal agent comprises a compound represented by N(R¹)(R²)(R³) or a salt thereof, or a compound represented by C(R¹)(R²)(R³)(R⁴) or a salt thereof, wherein R¹ to R³ and R¹ to R⁴ each independently represent a hydrogen atom, a carboxyl group, a hydroxyl group, a phosphonic acid group or a salt group thereof, or a substituted or unsubstituted linear or branched alkyl group having 1 or more and 5 or less carbon atoms, where one or more of R¹ to R³ are each a phosphonic acid group or a salt group thereof, or an alkyl group substituted with a phosphonic acid group or a salt group thereof, and one or more of R¹ to R⁴ are each a phosphonic acid group or a salt group thereof, or an alkyl group substituted with a phosphonic acid group or a salt group thereof.

6. The cleaning composition of claim 1, wherein the particle removal agent comprises 1-hydroxyethylidene-1,1-diphosphonic acid.

7. The cleaning composition of claim 1, wherein the base comprises 2-(diethylamino)ethanethiol, captamine, diethylethanolamine, methylcysteamine, 2-(tert-butylamino)ethanethiol, 2,2′-dimethoxy-1,1-dimethyl-dimethylamine, 3-amino-4-octanol, 3-butoxypropylamine, N-acetylcysteamine, homocysteamine, N,N-dimethylhydroxylamine, 2-(isopropylamino)ethanol, 2-(methylthioethyl)amine, 1-aminopropane-2-thiol, leucinol, cysteamine, and/or N,O-dimethylhydroxylamine.

8. The cleaning composition of claim 1, wherein the base comprises an alkylated amine.

9. The cleaning composition of claim 1, wherein the base comprises 3-amino-4-octanol.

10. The cleaning composition of claim 1, wherein the surfactant is represented by Formula (I):
CₘH₂ₘ₊₁—(OCH₂CH₂)ₙ-L-COOH (I),
where 6≤m≤20,
n≥5,
L is a bond, —O—, —S—, —R¹—, —S—R¹—, or —O—R¹—, where R¹ is a C₁₋₄ alkylene.

11. The cleaning composition of claim 1, wherein the surfactant comprises capryleth carboxylic acid.

12. The cleaning composition of claim 1,
wherein the reducing agent yields a standard reduction potential (E^{o}) of less than 1.224 V or comprises at least hydrogen peroxide;
wherein the particle removal agent comprises a compound represented by N(R¹)(R²)(R³) or a salt thereof, or a compound represented by C(R¹)(R²)(R³)(R⁴) or a salt thereof, wherein R¹ to R³ and R¹ to R⁴ each independently represent a hydrogen atom, a carboxyl group, a hydroxyl group, a phosphonic acid group or a salt group thereof, or a substituted or unsubstituted linear or branched alkyl group having 1 or more and 5 or less carbon atoms, where one or more of R¹ to R³ are each a phosphonic acid group or a salt group thereof, or an alkyl group substituted with a phosphonic acid group or a salt group thereof, and one or more of R¹ to R⁴ are each a phosphonic acid group or a salt group thereof, or an alkyl group substituted with a phosphonic acid group or a salt group thereof;
wherein the surfactant is represented by Formula (I):
CₘH₂ₘ₊₁—(OCH₂CH₂)ₙ-L-COOH (I),
where 6≤m≤20,
n≥5,
L is a bond, —O—, —S—, —R¹—, —S—R¹—, or —O—R¹—, where R¹ is a C₁₋₄ alkylene; and
wherein the base comprises an alkylated amine including a hydroxy group.

13. A cleaning composition for post-CMP cleaning of semiconductor surfaces, comprising: hydrogen peroxide; a particle removal agent; a surfactant; and a base.

14. The cleaning composition of claim 13, comprising: hydrogen peroxide; hydroxyethane-1,1-diphosphonic acid; capryleth-9-carboxylic acid; and 3-amino-4-octanol.

15. A method for simultaneously removing a pad stain from a polishing pad and removing particles from a semiconductor surface after polishing, comprising: supplying a cleaning composition according to claim 1 to the semiconductor surface; and contacting the semiconductor surface with the polishing pad in the presence of the cleaning composition to produce a polished semiconductor surface having a reduced defect count.

16. The method of claim 15, wherein the pad stain comprises MnO₂.

17. A method for producing a polished semiconductor surface, comprising: polishing a semiconductor surface with a polishing composition comprising a removal rate enhancer; and
simultaneously removing a pad stain from a polishing pad and removing particles from the semiconductor surface by the method according to claim 15.

18. The method of claim 17, wherein the removal rate enhancer comprises KMnO₄.

19. A method for simultaneously removing a pad stain from a polishing pad and removing particles from a semiconductor surface after polishing, comprising: supplying a cleaning composition according to claim 13 to the semiconductor surface; and contacting the semiconductor surface with the polishing pad in the presence of the cleaning composition to produce a polished semiconductor surface having a reduced defect count.

20. The method of claim 19, wherein the pad stain comprises MnO₂.
